(19) United States
(12) Patent Application Publication
(10) Pub. No.: US 2023/0059811 A1
(43) Pub. Date: Feb. 23, 2023

(54) BLOCKCHAIN-BASED SUPPLY CHAIN AND INVENTORY MANAGEMENT SYSTEM AND METHOD

(71) Applicant: NCR Corporation, Atlanta, GA (US)

(72) Inventor: Frank Joseph Lamont Gauld, Edinburgh (GB)

(21) Appl. No.: 17/404,104

(22) Filed: Aug. 17, 2021

(51) Int. Cl. G06Q 10/08; G06Q 30/00; G06F 16/23

(52) U.S. Cl. CPC G06Q 10/087; G06Q 10/0838; G06Q 30/018; G06F 16/2379

(57) ABSTRACT

A system and method for maintaining information about a product over the lifetime of a product. The system includes a network interface device, a database, a processing unit, and a memory device. The database stores product data in the form of a plurality of blockchains. Each of the plurality of blockchains corresponds to a separate product produced by the vendor. Each separate product has an assigned identification code. The memory device stores instructions executable by the processing unit to perform data processing activities. Information about a product to be assembled and sold by the vendor is received via the network interface device. A new blockchain is generated for that product and an identification code for the new product is associated with the new blockchain. The new blockchain is updated include information about an as-built hardware configuration for the new product and the new blockchain is stored in the database.

### FIELD

This disclosure relates generally to a blockchain-based supply chain and inventory management system and method.

### BACKGROUND

Increasingly, enterprises are deploying Self-Service Terminals (SSTs) at various locations for use by consumers. The locations can include financial institutions, grocery stores, retail stores, government venues, entertainment venues, gaming venues, transportation venues, and the like. The SSTs save the enterprises money by reducing onsite support staff and increasing the operational throughput by servicing consumers more efficiently. One of the most prevalent types of SST is an Automated Teller Machine (ATM). An SST is made up of a combination of hardware, software, and firmware modules that may be serviced (such as repair, update or replacement) from time-to-time. Monitoring the status of each module in an enterprise's fleet of SSTs is a considerable challenge. In one example, an agent software module in each SST monitors the status of each installed software module and forwards changes to central server-based software management system. This type of system is costly to implement, is inconsistently adopted by customers, and requires the installation and continued maintenance of the server-based system along with agents at each SST.

A blockchain is a ledger comprised of a growing list of records contained in linked blocks and secured by cryptographic techniques. Each block of a blockchain may contain transaction information, account information, information about one or more previous blocks, and other related information. A blockchain is typically implemented in a peer-to-peer network comprising a plurality of blockchain nodes adhering to a protocol for inter-node communication, transaction or block validation, and consensus formation. Blockchain provides a way to create and maintain permanent records and make the records accessible to a plurality of parties.

Accordingly, there is a need for a better way to monitor the status of each module in an enterprise's fleet of SSTs.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a blockchain-based supply chain and inventory management system according to the current disclosure;

FIG. 2 is a logical data diagram for showing aspects of the operation of the system of FIG. 1;

FIG. 3 is a diagram showing the lifecycle of an ATM and the corresponding entries in the blockchain when using the supply chain and inventory management system of the current disclosure;

FIG. 4 is a flowchart of the operation of a blockchain-based supply chain and inventory management method according to the current disclosure; and

FIG. 5 is a block diagram of a computing device for use with the a blockchain-based supply chain and inventory management system and method of the current disclosure.

### DETAILED DESCRIPTION

In the present disclosure, like reference numbers refer to like elements throughout the drawings, which illustrate various exemplary embodiments of the present disclosure. The description provided herein relates to an implementation addressed to automatic teller machines (ATMs) but the system and method disclosed herein can be applied to any type of product, including, e.g., self-service terminals (SST) in general.

The blockchain-based supply chain and inventory management system and method disclosed herein provides a ledger of ATM asset inventory indexed by the ATM identification code that includes various details related to each ATM, including, for example, the software, hardware, and firmware product and version levels. Multiple systems can access this ledger through software/API contracts to give the ATM owner control over who can access or update the information. As explained below, the ledger can track supply chain aspects of an ATM from assembly, build, distribution, and installation until it ultimately is retired and recycled. The system and method disclosed herein provides valuable tracking data for use in optimizing manufacturing processes and ATM servicing. In addition, the ability to centrally track product and software versions per ATM/customer is beneficial to relative to entitlement and subscription charging systems related to the user of an ATM or software installed therein.

The blockchain-based supply chain and inventory management system and method disclosed herein stores event-based data and other information related to an ATM, e.g., installed hardware modules, software, and firmware from initial order through to recycle. By using the blockchain approach, an independent and secure history can be maintained of each ATM.

The system and method described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices. Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

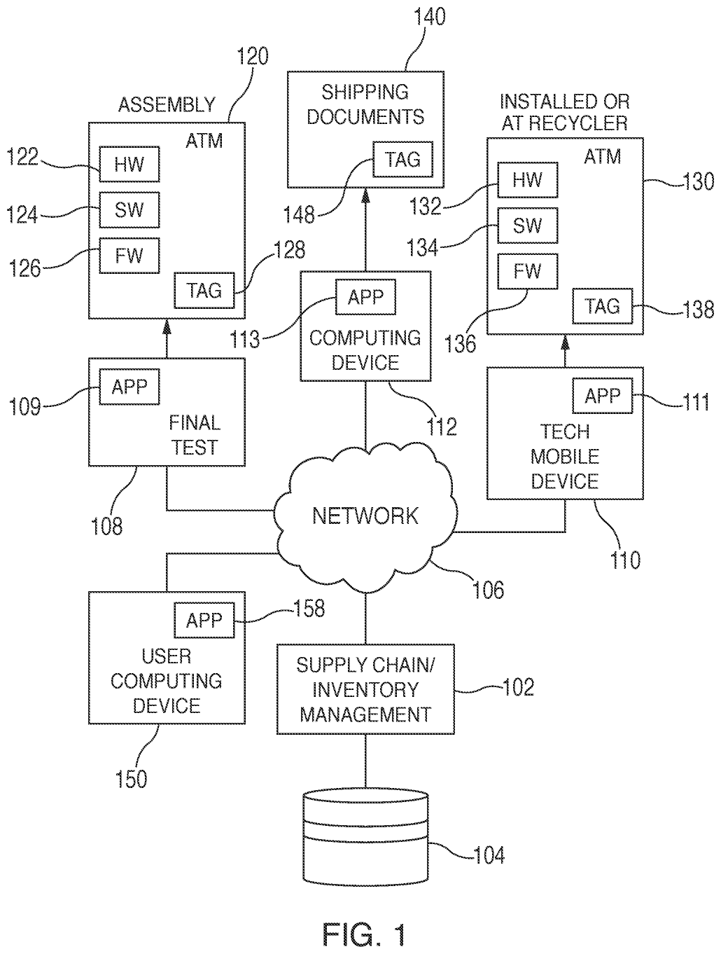

FIG. 1 is a block diagram of a system 100, according to an example embodiment. The system 100 is an example of a computing environment within which some embodiments may be implemented. The system 100 includes an supply chain/inventory management platform 102 deployed on a system of one or more servers and stores data in a database 104 attached either logically or physically thereto. The supply chain/inventory management platform 102 communicates over a network 106 with other entities, such as a final test system 108, a mobile device 110, a computing device 112, and a computing device 150 for a user.

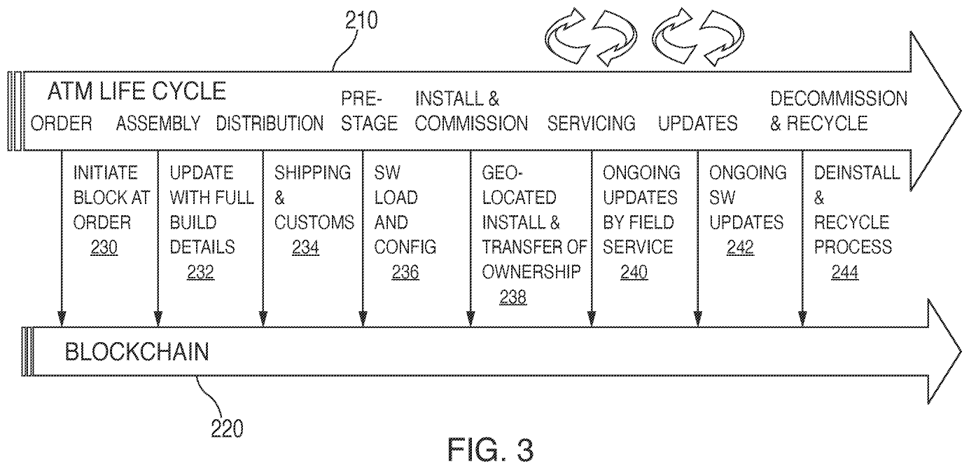

The supply chain/inventory management platform 102 is deployed on a server computer that includes a network interface device and communicates with a database storing status information related to the current (and prior) status of a fleet of SSTs such as ATM 120 and ATM 130. The status information for a particular ATM is provided via remote devices at various stages of the lifecycle of that ATM, as discussed with respect to FIG. 3. In one example shown in FIG. 1, the status information for an ATM 120 undergoing final assembly during manufacturing may be provided via an application 109 running on final test system 108. This status information may include a description of the hardware 122, software 124, and firmware 126 (type and revision) initially included within the ATM 120. This status information also includes the identification code for the ATM 120, which may be encoded within or otherwise associated with a tag 128 placed on the ATM 120, e.g., as a quick response (QR) code. In another example shown in FIG. 1, the status information for an ATM 130 that is installed in the field or present at a recycling facility may be provided via an application 111 running on a mobile device 110 of a technician. This status information may include a description of the hardware 132, software 134, and firmware 136 (type and revision) included within ATM 130 after servicing (e.g., upon update of one or more of the hardware, software or firmware) or upon disassembly during recycling (in order to track the various modules in an effort to reduce grey market trade or to ensure compliance with recycling regulations). This status information also includes the identification code for the ATM 130, which may be encoded within or otherwise associated with a tag 138 placed on the ATM 130, e.g., as a quick response (QR) code. In a third example shown in FIG. 1, the status information for an ATM to be shipped can be taken from shipping documents 140 and provided via an application 113 running on a computing device 112. This status information may include shipping, customs, and destination details, as well as the identification code for the ATM being shipped, which may be encoded within or otherwise associated with a tag 148 placed on the shipping documents. The applications 109, 111, 113 may be implemented as application programming interfaces (APIs) that interact with a software program or mobile device application.

A user may access information stored in database 104 using a computing device 150 using an application 158 stored thereon which communicates with the supply chain/inventory management platform 102 via network 106.

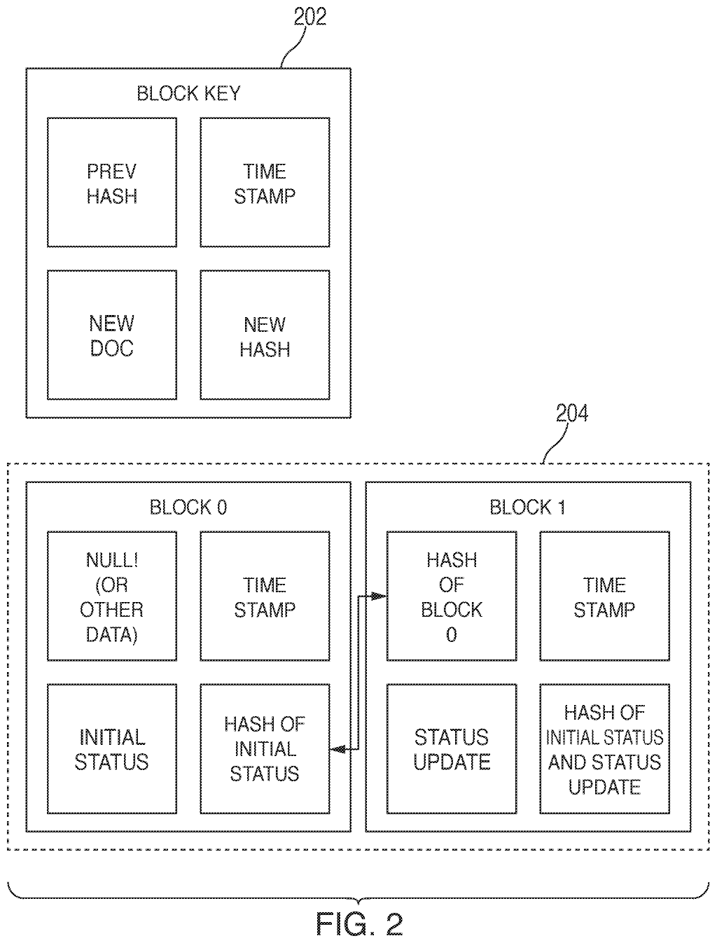

The data processing activities performed by the supply chain/inventory management platform 102 may include receiving, via the network interface device, a data representation of updated status information for a particular ATM based on the identification code for that ATM, and finding a match between the identification code and a blockchain for that ATM stored in database 104. The data processing activities may further include generating a new block for the identified blockchain for that ATM based on the updated status information, as discussed below, to provide an updated version of the blockchain data structure. An example of a blockchain data structure according to some embodiments is illustrated in FIG. 2. The data processing activities may then conclude by storing, on the memory device and/or in database 104, the updated version of the blockchain data structure.

FIG. 2 is a logical data diagram for showing aspects of the operation of the system of FIG. 1 The diagram of FIG. 2 first includes a BLOCK KEY diagram 202 illustrating the basic elements of a block in a block chain data structure. The BLOCK KEY diagram 202 includes four data elements, shown as PREV HASH, NEW DOC, TIME STAMP, and NEW HASH in FIG. 2. The PREV HASH block is a previous hash of a preceding block in a blockchain, which may be NULL, or have another indicative value, indicating that the block is an initial block in a blockchain. The NEW DOC block is what is added by the present block. In the present disclosure, the new document block is used to identify the current status of an ATM. The status may include, for example, the hardware, software, firmware revisions present at the initial manufacturing/assembly of the ATM. When the ATM is serviced and the hardware, software, and/or firmware is updated or added to, a new document (status entry) is added to a subsequent block as discussed below. The NEW HASH block is a hash value that takes into account the new document entry added by the block and an immediately prior document entry or hash thereof. The general principal of the new hash, generated with a private key of a public-private key pair, is that it is based on what is unique to the new block and the previous block such that the hash will provide a unique data element to verify the contents of the previously block and the new block in sequence within the blockchain data structure. The BLOCK KEY diagram 202 also shows a TIME STAMP block as the last data element. The time stamp block includes the date and time when the block was created.

For example, the blockchain data structure 204 includes two blocks, BLOCK 0 and BLOCK 1. BLOCK 0 is the first block and therefore has a NULL! value for the previous block as there is no preceding block and the new document entry is the initial status of the ATM. The hash value is therefore based just on a hash generated from the initial status. A time stamp is also added. Subsequently, BLOCK 1 is added to the blockchain data structure 204. The previous hash data element is the hash value from BLOCK 0 and operates as a pointer to the preceding block, thereby chaining BLOCK 1 to BLOCK 0. The entry in BLOCK 1 is a subsequent status update. The hash value is therefore generated based on the status update and either the initial status or the hash of the initial status from BLOCK 0. The time stamp is also present in BLOCK 1 and includes the date and time when BLOCK 1 is created. Each subsequent block is generated in a similar way, with the new doc entry being a status update at various points in time during the life of the ATM as discussed with respect to FIG. 3.

FIG. 3 is a diagram showing the lifecycle 210 of an ATM and the various points within that lifecycle 210 in which the blockchain data structure 220 for that ATM may be updated. The first block in the blockchain data structure 220 is created upon the initial order stage 230 for the ATM. An identification code for the ATM is used to identify the particular blockchain data structure. Next, a block is added to the blockchain data structure 220 with full build details at an assembly stage 232. A block may be added to the blockchain data structure 220 with shipping and/or customs details at a distribution stage 234. A block may be added to the blockchain data structure 220 with software loading and configuration information at a pre-staging stage 236. A block may be added to the blockchain data structure 220 with geo-location and ownership information at an installation and commissioning stage 238. Digital certificates may be used for ownership information. Information about the licensing status of the ATM may be added at this point as well. A block may be added to the blockchain data structure 220 with hardware update or repair information at one or more servicing steps 240. A block may be added to the blockchain data structure 220 with software or firmware revision information after one or more update steps 242. Finally, a block may be added to the blockchain data structure 220 with de-installation and/or recycling information at a decommission and recycling stage 244. Tracking decommissioned hardware modules aids on preventing gray market sales. Tracking recycling information can assist with green objectives and compliance with recycling initiatives and/or regulations. The various stages and steps shown in FIG. 3 are exemplary and all may not be required or occur in the order shown.

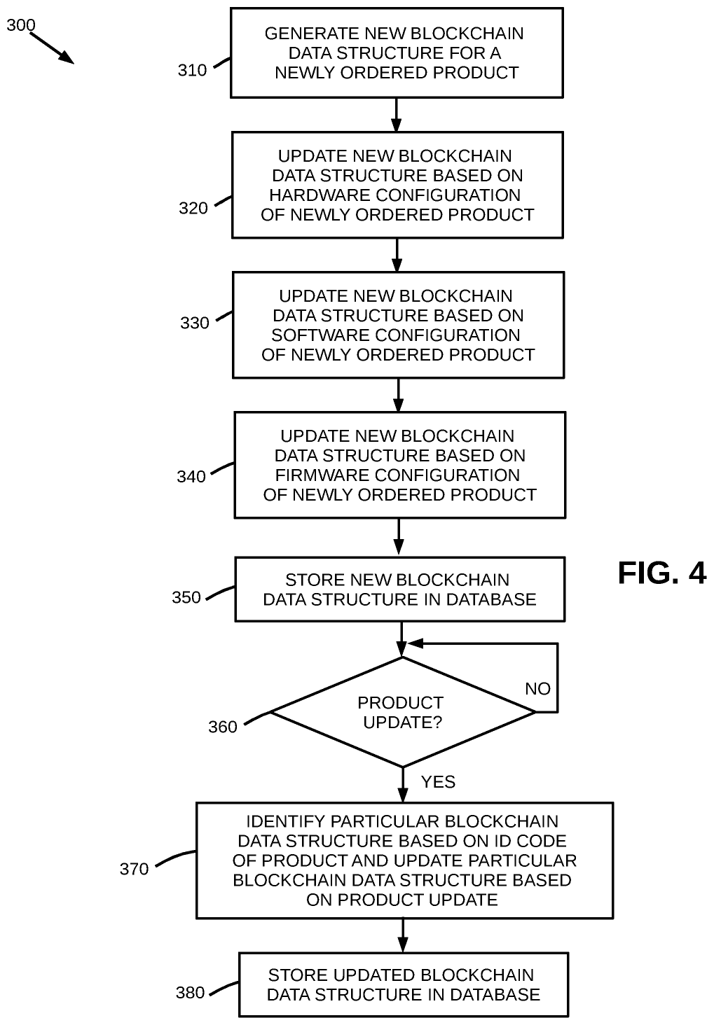

FIG. 4 is a flowchart 300 of the operation of a blockchain-based supply chain and inventory management method according to the current disclosure. The flowchart 300 is an example of a method that may be performed by a blockchain-based supply chain and inventory management system, such as the system 100 of FIG. 1, when applied to monitor the status of a product such as an ATM or other type of SST over its lifetime.

The method includes, as a first step 310, generating a new blockchain data structure for a newly ordered product. Next, at step 320, the new blockchain data structure is updated based on the hardware configuration of the newly ordered product. Further, at step 330, the new blockchain data structure is updated based on the software configuration of the newly ordered product. Thereafter, at step 340, the new blockchain data structure is updated based on the firmware configuration of the newly ordered product. At step 350, the new blockchain data structure is stored in a database. Thereafter, whenever there is an update to a particular product (i.e., step 360), the particular blockchain data structure for that particular product is identified based on its associated identification code and the particular blockchain data structure is updated to reflect the product update (i.e., step 370). As evident, for the purposes of this application, a product update may refer to any information about the product that a manufacturer or owner may desire to be tracked. This includes but is not limited to the information shown in FIG. 3 and described above. Once the particular blockchain data structure has been updated, the updated particular blockchain data structure is stored in the database (i.e., step 380).

The system and method disclosed herein are based on a series of controlled processes which lend themselves well to writing blockchains in an indelible blockchain update. The disclosed combination of controlled processes and committed blockchain updates is important to a number of supporting processes which rely on accurate data—such as customs, transfer of assets, RoHS recycling, etc. and thus provides a distinct advantage over standard database implementations.

The blockchain data generated by the system and method disclosed herein provides a great value to supply chain and inventory management systems and additionally supports valuable offline analytics for examining patterns of system usage and behavior over time and in different conditions. Heretofore it was very difficult to obtain reliable and accurate time stamped data from large, geo-located SSTs for analysis that included information about all hardware, modules, firmware and software configurations of each SST. The types of analysis beneficial for a fleet of SSTs may include, for example, degradation of performance, wear of parts, performance in climatic conditions (using timestamp and geo-data to index weather patterns), quality of service. This type of data also supports rapid impact analysis for emergency or mandatory updates—e.g., quickly identifying which SST requires what update and where. Without this type of data organization, it can takes months of intensive work to yield such impact analysis, driving up cost and lengthening the timescales for emergency field retrofits and firmware/software updates. Finally, proactive benefits are obtained using the system and method of the present disclosure including, for example, the identification of patterns of usage/performance for benchmarking purposes, thereby improving servicing of other units and proactively reducing the total cost of ownership.

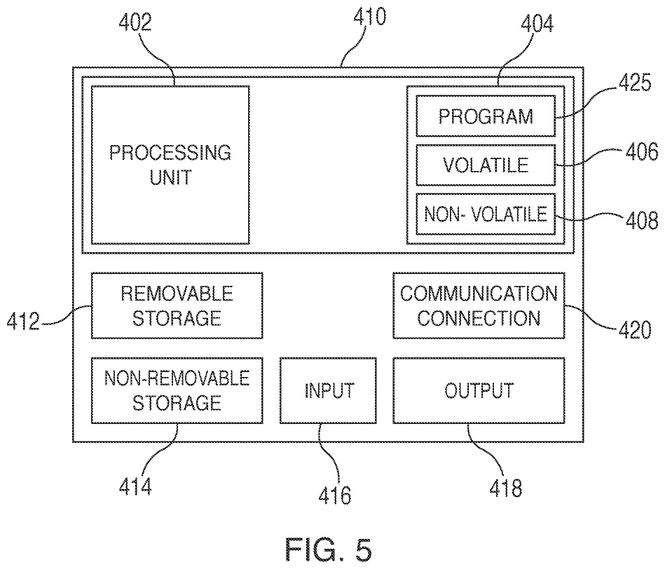

FIG. 5 is a block diagram of a computing device for use with the blockchain-based supply chain and inventory management system and method of the current disclosure. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 5. Devices such as smartphones, tablets, and smartwatches are generally collectively referred to as mobile devices. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A method comprising:
maintaining a database of products produced by a vendor, the database including a plurality of blockchain data structures, each of the plurality of blockchain data structures corresponding to a separate product produced by the vendor, each separate product having an assigned identification code;
generating a new blockchain data structure for a new product to be assembled and sold by the vendor and associating an identification code for the new product with the new blockchain data structure;
updating the new blockchain data structure to include information about an as-built hardware configuration for the new product; and
storing the new blockchain data structure in the database.

2. The method of claim 1, further comprising updating the new blockchain data structure to include information about an as-built software configuration for the new product.

3. The method of claim 1, further comprising updating the new blockchain data structure to include information about an as-built firmware configuration for the new product.

4. The method of claim 1, further comprising updating the new blockchain data structure to include information about shipping details for the new product.

5. The method of claim 1, further comprising updating the new blockchain data structure to include information about ownership information for the new product.

6. The method of claim 1, further comprising:
identifying a particular blockchain data structure in the database based on the identification code for a particular product;
updating the identified blockchain data structure to include information about hardware updates for the particular product.

7. The method of claim 2, further comprising;
identifying a particular blockchain data structure in the database based on the identification code for a particular product;
updating the identified blockchain data structure to include information about software updates for the particular product.

8. The method of claim 3, further comprising:
identifying a particular blockchain data structure in the database based on the identification code for a particular product;
updating the identified blockchain data structure to include information about firmware updates for the particular product.

9. The method of claim 1, further comprising:
identifying a particular blockchain data structure in the database based on the identification code for a particular product;
updating the identified blockchain data structure to include information about decommissioning of the particular product.

10. The method of claim 1, further comprising:
identifying a particular blockchain data structure in the database based on the identification code for a particular product;
updating the identified blockchain data structure to include information about licensing status of the particular product.

11. A system comprising:
a network interface device;
a database storing data of products manufactured by a vendor, the database including a plurality of blockchain data structures, each of the plurality of blockchain data structures corresponding to a separate product produced by the vendor, each separate product having an assigned identification code;
a processing unit;
a memory device storing instructions executable by the processing unit to perform data processing activities comprising:
receiving, via the network interface device, a data representation of a product to be assembled and sold by the vendor,
generating a new blockchain data structure for the product to be assembled and sold by the vendor and associating an identification code for the new product with the new blockchain data structure,
updating the new blockchain data structure to include information about an as-built hardware configuration for the new product, and
storing the new blockchain data structure in the database.

12. The system of claim 11, wherein the instructions stored in the memory device executable by the processing unit to perform data processing activities further comprise updating the new blockchain data structure to include information about an as-built software configuration for the new product.

13. The system of claim 11, wherein the instructions stored in the memory device executable by the processing unit to perform data processing activities further comprise updating the new blockchain data structure to include information about an as-built firmware configuration for the new product.

14. The system of claim 11, wherein the instructions stored in the memory device executable by the processing unit to perform data processing activities further comprise updating the new blockchain data structure to include information about shipping details for the new product.

15. The system of claim 11, wherein the instructions stored in the memory device executable by the processing unit to perform data processing activities further comprise updating the new blockchain data structure to include information about ownership information for the new product.

16. The system of claim 11, wherein the instructions stored in the memory device executable by the processing unit to perform data processing activities further comprise:
identifying a particular blockchain data structure in the database based on the identification code for a particular product;
updating the identified blockchain data structure to include information about hardware updates for the particular product.

17. The system of claim 12, wherein the instructions stored in the memory device executable by the processing unit to perform data processing activities further comprise;
identifying a particular blockchain data structure in the database based on the identification code for a particular product;
updating the identified blockchain data structure to include information about software updates for the particular product.

18. The system of claim 13, wherein the instructions stored in the memory device executable by the processing unit to perform data processing activities further comprise:
identifying a particular blockchain data structure in the database based on the identification code for a particular product;
updating the identified blockchain data structure to include information about firmware updates for the particular product.

19. The system of claim 11, wherein the instructions stored in the memory device executable by the processing unit to perform data processing activities further comprise:
identifying a particular blockchain data structure in the database based on the identification code for a particular product;
updating the identified blockchain data structure to include information about decommissioning of the particular product.

20. The system of claim 11, wherein the instructions stored in the memory device executable by the processing unit to perform data processing activities further comprise:
identifying a particular blockchain data structure in the database based on the identification code for a particular product;
updating the identified blockchain data structure to include information about licensing status of the particular product.
